(19) United States
(12) Patent Application Publication
(10) Pub. No.: US 2025/0018614 A1
(43) Pub. Date: Jan. 16, 2025

(54) NOZZLE BOX DEVICE AND STRETCHING UNIT

(71) Applicant: BRÜCKNER MASCHINENBAU GmbH, Siegsdorf (DE)

(72) Inventor: Anton WETTEMANN, Vachendorf (DE)

(21) Appl. No.: 18/767,620

(22) Filed: Jul. 9, 2024

(30) Foreign Application Priority Data
Jul. 10, 2023 (DE) 102023118120.3

(51) Int. Cl. B29C 35/04; B29C 35/16; B29C 55/02

(52) U.S. Cl. CPC B29C 35/045; B29C 35/16; B29C 55/02; B29C 2035/1658

(57) ABSTRACT

A nozzle box device for an oven of a stretching unit is disclosed having a nozzle box and a supporting device for the nozzle box. The supporting device includes a first support and a second support. The first support is designed to be height adjustable in such a way that the nozzle box is adjustable between an operating position and an assembly position, wherein a first end of the nozzle box is situated lower in the assembly position than in the operating position.

### CROSS RELATED APPLICATION

This application claims priority to German Application DE 10 2023 118 120.3, filed Jul. 10, 2023, the entire contents of which is hereby incorporated by reference.

### FIELD OF THE DISCLOSURE

The disclosure relates to a nozzle box device for an oven of a stretching unit as well as a stretching unit comprising an oven.

### BACKGROUND

Stretching units are used in particular in the production of plastics films. Typically, the film to be stretched moves in such units through an oven of the unit in a drawing direction by means of a film transport system. The film to be stretched is heated before the stretching process and also kept at a predetermined temperature in, during and after the stretching process. Subsequently, the stretched film is cooled in the oven.

To control the temperature of the oven and the film, nozzle boxes are used that extend in the transverse direction along the film and comprise a plurality of outlet openings that are directed towards the film. Temperature-controlled air is conveyed through the nozzle boxes, said air flowing through the outlet openings towards the film and heating or cooling the film.

Such nozzle boxes are typically mounted fixedly on supports above and below the film and are extremely difficult to access. If there are malfunctions in the oven, which mean the removal of one of the nozzle boxes is necessary, the other nozzle boxes must also be frequently removed in order to reach the desired nozzle box. This results in lengthy outage times of the stretching unit due to the time-consuming removal of the nozzle boxes from the oven.

### SUMMARY

There is provided a nozzle box device as well as stretching unit, in which the nozzle boxes can be installed and removed more simply.

The object is solved by means of nozzle box device for an oven for a stretching unit, in particular a transverse direction orienter, a machine direction orienter and/or a simultaneous stretching unit, comprising a nozzle box and a supporting device for the nozzle box. The supporting device comprises a first support and a second support. The nozzle box is connected to the first support and the second support. The first support is designed to be height adjustable in such a way that the nozzle box is adjustable between an operating position and an assembly position, wherein a first end of the nozzle box is situated lower in the assembly position than in the operating position.

Due to the height-adjustment capability of the first support, it is possible to individually remove the nozzle boxes laterally, i.e. in the transverse direction, in particular along a removal path below one of the transport rails of the film transport system. As a result, it is possible to remove the nozzle boxes from the stretching unit quickly and to refit the stretching unit with nozzle boxes quickly.

The connection of the nozzle box to the supports can also occur indirectly.

For example, the nozzle box is connected by means of a first one of its sides to the first support and by means of the second one of its sides to the second support, in particular in relation to the transverse direction (i.e. the longitudinal direction of the nozzle box). The first end is located on the first side of the nozzle box.

The direct or indirect connection between the nozzle box and the first support can be arranged on the first side at the end face on the first end of the nozzle box, adjoining the end face, or further offset towards the centre.

The direct or indirect connection between the nozzle box and the second support can be arranged on the second side at the end face on the second end of the nozzle box, on adjoining the end face, or further offset towards the centre.

In an embodiment, the supporting device comprises a rail, on which the nozzle box is mounted, wherein the rail is connected on a first side to the first support and on a second side to the second support, wherein a first end of the rail is situated lower in the assembly position than in the operating position. In this way, the stability of the nozzle box device is increased.

It is conceivable that the supporting device is formed from one or more rails, one or more first supports and one or more second supports as well as, optionally, the actuation device.

For example, the rail is connected by means of a first one of its sides to the first support and by means of the second one of its sides to the second support, in particular in relation to the transverse direction (i.e. the longitudinal direction of the rail). The first end is located thus on the first side of the rail.

The direct or indirect connection between the rail and the first support can be arranged on the first side at the end face on the first end of the rail, on the adjoining end face, or further offset towards the centre.

The direct or indirect connection between the rail and the second support can be arranged on the second side at the end face on the second end of the rail, on the adjoining end face, or further offset towards the centre.

The connection of the rail to the supports can be direct or can be indirect, e.g. by means of longitudinal braces.

It is also conceivable that the supporting device comprises frame that is connected directly to the supports, wherein the rails are attached to the frame.

The first and second ends of the nozzle box can be aligned correspondingly to the first or second ends of the rails.

In an embodiment, the rail and/or the nozzle box is arranged horizontally in the operating position, thereby enabling temperature-controlled air to be blown onto the film particularly uniformly.

The rail and/or the nozzle box can be tilted in relation to a horizontal plane during adjustment from the operating position into the assembly position in order to simplify the removal further.

In an embodiment, the first support comprises two members which are attached pivotably to each other and at least one of the members is pivotable in relation to the rail and/or the nozzle box, in particular wherein the members stand vertically and are aligned to each other in the operating position. In this way, a simple but stable first support is provided.

The members can be fixed into position mechanically in the operating position.

To simplify the supporting device, the second support can be a static support and/or the rail and/or the nozzle box, in particular the second side, for example the second end of the rail and/or the nozzle box, can be attached pivotably on the second support.

A static support is understood to mean that the support is not adjustable in height. The second support can thus comprise or be a vertical member.

It is also conceivable that the second support is also designed to be adjustable in height. Both ends of the rails and/or the nozzle box can then be situated lower in the assembly position than compared to the operating position.

In an embodiment, the nozzle box is arranged to be slidable on the rail and/or removable from the supporting device via the first end of the rail, thereby simplifying the removal and installation of the nozzle box further.

In an embodiment, the supporting device comprises two first supports and one first longitudinal brace, wherein the first longitudinal brace connects the two first supports to each other, thereby increasing the stability of the supporting device.

It is conceivable that the longitudinal braces are connected by means of one or more cross braces and form together parts of a frame.

For example, the supporting device comprises two second supports and one second longitudinal brace, wherein the second longitudinal brace connects the two second supports to each other, thereby increasing the stability of the supporting device.

The rail and/or the nozzle box can extend transversely to the first and/or second longitudinal braces and/or is attached to the first and/or second longitudinal braces, thereby increasing the stability of the supporting device further.

The rail and/or the nozzle box is attached to the first and second supports in particular via the first and/or the second longitudinal braces.

The second longitudinal brace can comprise a joint with a pivot axis in the drawing direction. As a result, attachment of the rail and/or the nozzle box occurs pivotably on the second supports.

In an embodiment, the supporting device comprises multiple rails and/or nozzle boxes which are aligned parallel to each other and which attach on the first and/or second longitudinal braces next to each other, thereby enabling multiple nozzle boxes to be accommodated on a supporting device.

For simple actuation, the supporting device can comprise an actuation device, wherein the actuation device is configured to adjust the height of the first support.

It is conceivable that parts of the actuation device or the actuation device as a whole are not permanently attached to the remaining supporting device, but only mounted as required. This is advantageous as fewer actuation devices are required.

It is also conceivable that the height adjustment of the supports can be power-driven, thus the actuation device comprises a drive unit, such as an electric motor or the like.

In an embodiment, the actuation device is a screw jack comprising a threaded spindle and a spindle nut, by means of which the height of the first support can be adjusted reliably.

For example, the actuation device is arranged on the first side of the supporting device. The spindle nut can be attached to the first longitudinal brace.

In an embodiment, the nozzle box device comprises multiple nozzle boxes, in particular wherein the nozzle boxes are aligned parallel to each other and are arranged next to each other in the drawing direction. As a result, multiple nozzle boxes can be moved simultaneously into the assembly position in order to reduce the outage times of the stretching unit further.

In particular, each nozzle box is arranged on its own rail. For example, four nozzle boxes exist on one supporting device.

A cover separate from the nozzle boxes can be arranged between two adjacent nozzle boxes and/or a perforated wing protrudes on the outlet side of the nozzle box in the drawing direction towards an adjacent nozzle box. The set-up time is reduced further by means of the perforated wing that is part of the nozzle box.

The cover is, for example, a perforated cover or without any perforations.

The outlet side is, for example, the upper side of the nozzle box, i.e. the side from which the air is blown towards the film.

For example, the perforated wings of adjacent nozzle boxes completely cover the interstice between the respective nozzle boxes completely and/or abut onto each other.

In an embodiment, the nozzle box comprises a plurality of outflow openings which are provided on the outlet side of the nozzle box and/or the nozzle box has an inlet side with an air inlet opening, wherein the inlet side is located on the second side of the nozzle box. In this way, reliable and uniform air flow is ensured onto the film.

For example, the nozzle box comprises a base body and an attachment that is attached to the base body, wherein the attachment comprises the outflow openings. In this way, the nozzle box can be used versatilely.

There is also provided a stretching unit, in particular a transverse direction orienter, a machine direction orienter and/or a simultaneous stretching unit comprising a film transport system and an oven comprising a nozzle box device as described previously, in particular wherein the rail and/or the nozzle box are arranged transversely to the drawing direction.

The features and advantages described for the supporting device apply equally to the stretching unit and vice versa. The nozzle box device and the nozzle box are located in particular under the film transport system and/or under the film.

The oven and the supporting device have a drawing direction that corresponds to the direction of travel of the film during operation of the stretching unit as well as a transverse direction that is horizontal and transverse to the drawing direction.

For example, the first side, the second side, the first end and the second end of the rail and/or the nozzle box are sides and ends in the transverse direction. The first side and the first end of the rail and thus the first side of the supporting device can be situated on what is termed the assembly side of the stretching unit.

For example, the oven comprises an oven base, on which the supporting device is attached, in particular on which the supports are attached.

The threaded spindle of the actuation device can be attached pivotably to the oven base or the remaining supporting device.

In an embodiment, the film transport system comprises two transport rails which are arranged in the transverse direction at a spacing from each other, wherein the nozzle box is removable from the oven in the assembly position of the supporting device along a removal path below one of the transport rails, and/or wherein the nozzle box is arranged in the operating position of the supporting device at least in part within the spacing.

In particular, the outlet side of the nozzle box is arranged with the outflow openings within the spacing.

In an embodiment, the stretching unit comprises an air supply, wherein the inlet side of the nozzle box connects to the air supply in the operating position of the supporting device, thereby enabling the nozzle boxes to be removed from the oven independently of the air supply.

### BRIEF DESCRIPTION OF THE DRAWINGS

Additional advantages and features of the disclosure can be found in the following description as well as in the attached drawings to which reference is made. In the drawings:

FIG. 1 shows a stretching unit according to an embodiment of the disclosure in a schematic top view,

FIG. 2 shows a schematic sectional view of parts of the stretching unit comprising a nozzle box device according to the embodiment of the disclosure in the operating position,

FIG. 3 shows an enlarged schematic sectional view of two adjacent nozzle boxes of the nozzle box device according to FIG. 2,

FIG. 4 shows a schematic sectional view according to FIG. 2 comprising a nozzle box device in the assembly position,

FIG. 5 shows a perspective view of a nozzle box device according to a second embodiment of the disclosure in the assembly position, and

FIG. 6 shows a schematic sectional view of parts of the stretching unit comprising a nozzle box device according to a third embodiment of the disclosure in the operating position.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C” or as “at least one of A, B or C”. The same holds true for listings with more than three items.

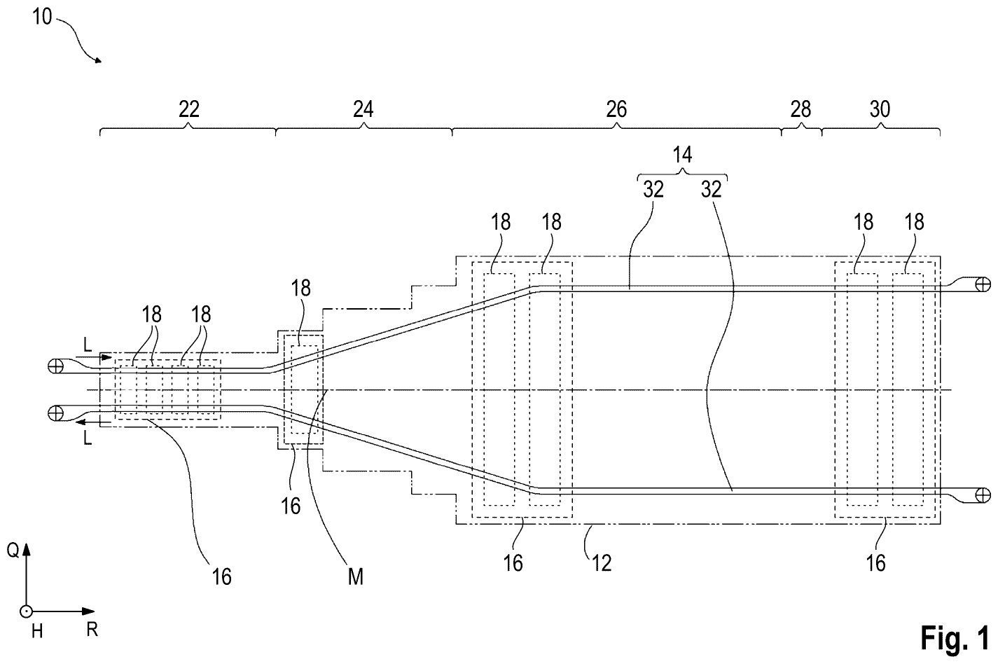

In FIG. 1, a stretching unit 10 according to the disclosure is shown extremely schematically.

In the shown first embodiment, the stretching unit is termed a transverse direction orienter (TDO). It is also conceivable that the unit is a machine direction orienter or a simultaneous stretching unit.

The stretching unit 10 comprises an oven 12, a film transport system 14 and a nozzle box device 16 comprising at least one nozzle box 18.

The oven 12 has a drawing direction R which corresponds to the direction of travel of the film F to be stretched. The transverse direction Q of the oven 12 runs transversely to the drawing direction R and horizontally and the vertical direction H runs vertically.

Along the drawing direction R, the oven 12 has different zones for treating the film F to be stretched.

The film F is heated in the first zone 22, also termed the preheating zone. the In subsequent second zone (“stretching zone”), the film F is stretched in the transverse direction Q so that its width is greater at the end of the second zone 24 than it was at the start.

After completing the stretching, the film F passes through the third zone 26 (termed “heat treatment zone”, “further heating zone” and/or “annealing zone”), in which a relaxation of the film F can take place at high temperatures.

Subsequently, the film F then passes through a fourth zone 28 and a fifth zone 30 (“cooling zone”), wherein the film F is cooled in the fifth zone 30.

The fourth zone 28 is termed the neutral zone and separates the third zone 26 from the fifth zone 30. The neutral zone is, for example, an empty space without any ventilation.

The film transport system 14 comprises two transport rails 32 in the known manner which are arranged relative to a middle plane M of the stretching unit 10 or the oven 12 mirror-symmetrically at a spacing and which extend at least in part in the oven 12.

In an entry zone as well as an exit zone, in which the film F of the stretching unit 10 is fed and removed, the transport rails 32 run outside of the oven 12.

The film F is gripped in the known manner by grippers (not shown) of the film transport system 14, which are guided along the transport rails 32, and is transported through the oven 12 in the drawing direction R.

Multiple nozzle box devices 16 are provided in the oven, wherein the nozzle box devices 16 are indicated only in part in FIG. 1 for the sake of clarity.

The nozzle box devices 16 are used to direct temperature-controlled air onto the film F in order to control the temperature of the film F, thus to heat or to cool the film F.

Thus, nozzle box devices 16 can be provided in the first zone 22, the second zone 24, the third zone 26 and, for cooling, also in the fifth zone 30. In FIG. 1, not all nozzle box devices 16 and nozzle boxes 18 of the stretching unit 10 have been shown for the sake of clarity.

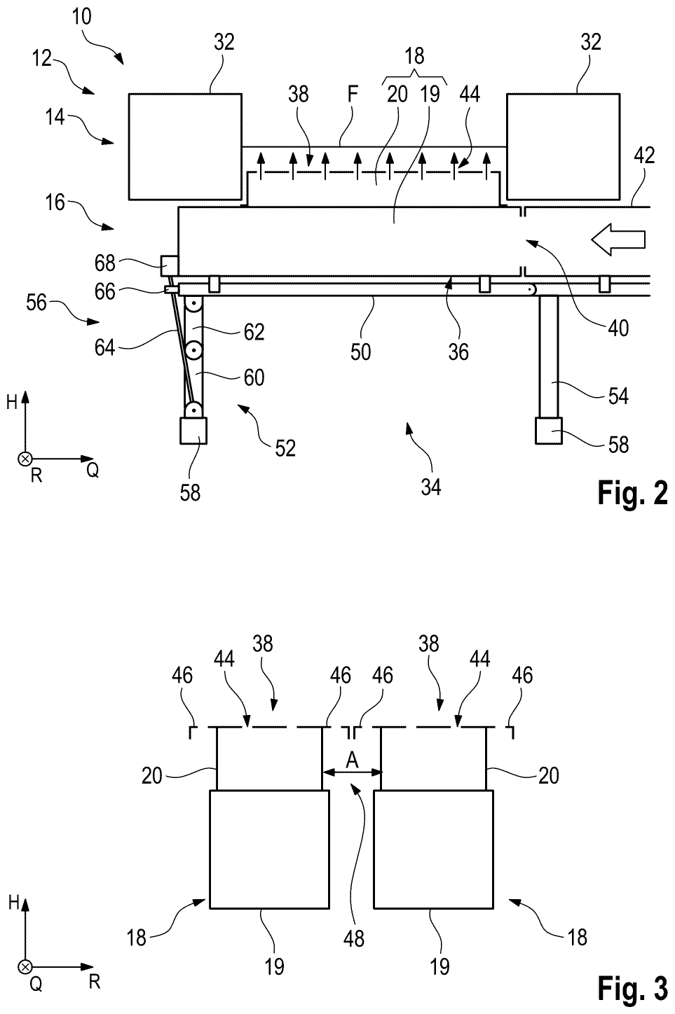

FIG. 2 shows a section through the stretching unit 10 in the region of one of the nozzle box devices 16, wherein only some parts of the stretching unit 10 are shown for the sake of clarity.

FIG. 2 shows the film transport system 14, more specifically the transport rails 32 with the film F running between them as well as the nozzle box device 16.

The nozzle box device 16 comprises a supporting device 34 as well as a nozzle box 18 that is attached to the supporting device 34.

Only one supporting device 34 and one nozzle box 18 are visible in FIG. 2. However, there are multiple nozzle boxes 18 and there can also be multiple supporting devices 34.

The nozzle boxes 18 are aligned in the transverse direction Q and are situated next to each other in the drawing direction R. The nozzle boxes 10 are, in particular, parallel to each other.

Each of the nozzle boxes 18 is designed hollow, in the known way, and comprises an inlet side 36 as well as an outlet side 38. The outlet side 38 corresponds, for example, to the upper side of the nozzle box 18.

The nozzle box 18 has an air inlet opening 40 on the inlet side 36, said air inlet opening 40 connecting to the air supply 42 of the stretching unit 10.

On its outlet side 38, the nozzle box 18 has a plurality of outflow openings 44 that face the film F.

In the transverse direction Q, the nozzle box 18 can comprise a first side and a first end (on the left in FIG. 2) as well as a second side and a second end (on the right in FIG. 2).

The first and the second sides are the regions on different sides of the centre of the nozzle box 18 in the transverse direction Q (i.e. left and right of the centre with regard to FIG. 2).

The nozzle box 18 can have multiple parts and can comprise a base body 19 and an attachment 20.

The attachment 20 is mounted on the base body 19 on its upper side, wherein the outflow openings 44 are provided in the attachment 20.

In particular, the base body 19 does not extend in the spacing between both transport rails 32, but rather only the attachment 20 extends into the spacing between both transport rails 32.

As indicated in FIG. 2 by the arrows, temperature-controlled air can flow through the air supply 42 and the air inlet opening 40 into the nozzle box 18 during operation of the stretching unit 10. The temperature-controlled air is then conveyed uniformly onto the film F through the outflow openings 44, said film F being heated or cooled as a result.

Air returning from the film F can flow between the nozzle boxes 18. This is shown schematically in FIG. 3, in which two adjacent nozzle boxes 18 are shown in section along the drawing direction R.

Adjacent nozzle boxes 18 are arranged at a spacing A to each other so that an interstice 48 is formed between them, through which the air can flow.

In the shown embodiment, two perforated wings 46 are provided in each case on the nozzle boxes 18 on the outlet side 38, said perforated wings 46 extending in particular over the entire length or a partial region of the nozzle box 18 in the transverse direction Q.

The wings 46 are attached, in particular, to the attachments 20.

With regard to the drawing direction R, the wings 46 extend in opposing directions, i.e. one wing 46 extends in the drawing direction R and one wing extends counter to the drawing direction R.

The length of each wing 46 in and counter to the drawing direction R equals, for example, half of the spacing A of the nozzle boxes 18 from each other so that the mutually facing wings 46 of adjacent nozzle boxes 18 completely cover the interstice 48 between the nozzle boxes 18, wherein some play or an assembly clearance can exist between the wings 46. The wings 46 can also abut onto each other.

It is conceivable that the nozzle boxes 18 do not comprise any wings 46, but rather a separate cover—i.e. a perforated cover or a non-perforated cover—is provided between the nozzle boxes 18, said cover covering the interstice 48. It is also conceivable that the interstice 48 remains open, thus is not covered.

As can be seen in FIG. 2, the nozzle boxes 18, more specifically the attachments 18b, project into the spacing between the transport rails 32 of the film transport system 14 in the operating position.

In particular, the outlet side 38, together with the outflow openings 44, is arranged spaced between both transport rails 32, i.e. in the vertical direction and the transverse direction Q between the transport rails 32.

The supporting device 34, which is shown in its operating position in FIG. 2, comprises a rail 50, a first support 52, a second support 54 and an actuation device 56.

The rails 50 and the nozzle box 18 extend in the transverse direction Q.

For example, a separate supporting device 34 is provided for each nozzle box 18.

The nozzle box 18 is arranged to be slidable on the rail 50 of the supporting device 34 so that the nozzle box 18 can be slid along the rail 50 in the transverse direction Q. In the operating position, the nozzle box 18 is however fixed into position on the rail 50 in order to prevent undesired movements.

In the shown embodiment, the rail 50 and the nozzle box 18 that is thus situated on it are aligned horizontally in the operating position.

The rail 50 comprises a first side with a first end in the transverse direction Q that is connected to the first support 52 as well as a second side with a second end in the transverse direction Q that is connected to the second support 54.

The first side and the first end of the nozzle box 18 correspond to the first side and the first end of the rail 50. Similarly, the second side and the second end of the nozzle box 18 correspond to the second side and the second end of the rail 50.

The air supply 42 of the stretching unit 10 is arranged on the second side of the rail 50 and thus the entire supporting device 34; the inlet side 36 of the nozzle box 18 is also aligned towards the second end of the rail 50.

The second end of the rail 50 is attached pivotably onto the second support 54 about a pivot axis, wherein the pivot axis runs in the drawing direction R.

The second support 54 is a static support, i.e. the height of the second support 54 is not adjustable. The second support 54 can thus be regarded an vertical member.

For example, the second support 54 is attached to an oven base 58 of the oven 12.

It is similarly conceivable that the second support 54 is also designed to be height adjustable, for example identical to the first support 52. Both ends of the rails 50 can then be situated lower in the assembly position than compared to the operating position.

However, the first support 52 is designed to be height adjustable.

In the shown embodiment, the first support 52 comprises a first member 60 and a second member 62.

The first member 60 is attached to the oven base 58 pivotably by means of one of its ends and is attached to the second member 62 pivotably by means of the other one of its ends.

The second member 62 is connected on its first end to the first member 60 and on the other end pivotably to the rail 50.

The pivot axes of these three pivotable connections run parallel to each other and in the drawing direction R.

As can be seen in FIG. 2, both members 60, 62 stand vertically and are aligned to each other in the operating position of the supporting device 34. In addition, both members 60, 62 can be fixed into position to each other mechanically in the shown operating position.

The height of the first support 52, i.e. the spacing between the upper end of the second member 62 and the lower end of the first member 60, is thus adjustable.

The actuation device 56 is provided to adjust the height, said actuation device 56 in the shown embodiment being a screw jack comprising a threaded spindle 64 and a spindle nut 66.

It is conceivable that parts of the actuation device 56 or the actuation device 56 as a whole are not permanently attached to the remaining supporting device 34, but are only mounted to the supporting device 34 to be actuated as required.

Optionally, the actuation device 56 can comprise a drive unit 68, such an electric motor, for actuation of the threaded spindle 64.

If a drive unit 68 is provided, the height can also be adjusted using a means other than a threaded spindle.

The spindle nut 66 is connected fixedly to the first side of the rail 50 and the threaded spindle 64 extends through the spindle nut 66.

The threaded spindle 64 is connected pivotably to the oven base 58, wherein the pivot axis also runs in the drawing direction R here.

Thus, the spindle nut 66 is raised or lowered by actuating the threaded spindle 64, thereby changing the height of the first support 52.

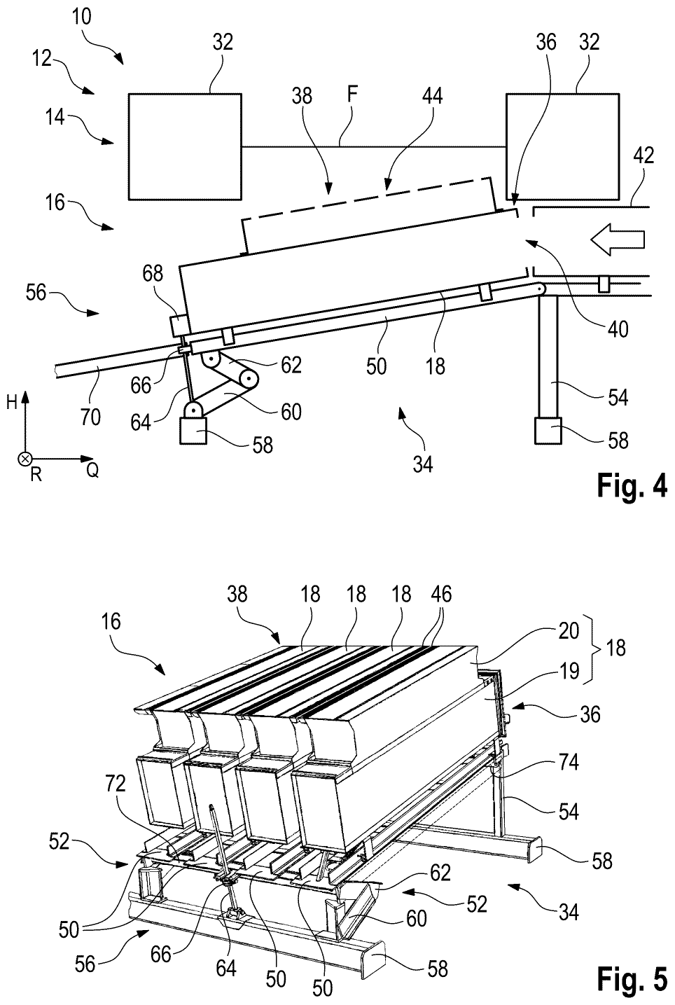

From the operating position shown in FIG. 2, the supporting device 34 can be moved into the assembly position shown in FIG. 4 by means of the actuation device 56. To this end, the threaded spindle 64 is actuated, for example by means of the drive unit 68, so that the first support 52 is shortened. As a result, the rail 50 pivots relative to the second support 54 and the first end of the rail 50 lowers. The rail 50 is thus tilted in relation to the horizontal plane when transitioning from the operating position into the assembly position.

In the assembly position, the first end of the rail 50 and thus the first end of the nozzle box 18 is now considerably lower than in the operating position, and in particular lower than the second end of the rail 50 and the nozzle box 18.

In this assembly position, the nozzle box 18 can now be removed from the supporting device 34 and from the oven 12.

To this end, the nozzle box 18 is slid out from the rail 50 of the supporting device 34 below the transport rails 32 of the film transport system 14.

To simplify this, an auxiliary rail 70 of the stretching unit 10 can be attached to the first side of the rail 50 in order to be capable of transporting the nozzle box 18 continuously.

By lowering the first support, a removal path for the nozzle box 18 is thus provided below one of the transport rails 32 of the film transport system 14, via which one individual nozzle box 18 can be removed from the oven 12 of the stretching unit 10 easily.

To insert a nozzle box 18, the nozzle box 18 is slid over the auxiliary rail 70 onto the rail 50 of the supporting device 34 and fixed into position on the rail 50.

Then the actuation device 56 is actuated once again to increase the height of the first support 52 and thus raise the first end of the rail 50 to the height of second end of the rail 50. Thus, the nozzle box 18 is inserted in the spacing between the two transport rails 32 of the film transport system 14 until the operating position shown in FIG. 2 is attained again.

In FIG. 5, a second embodiment of the supporting device 34 according to the disclosure is shown.

The supporting device 34 of the second embodiment substantially corresponds to the first embodiment so that only the differences are discussed hereinafter. Identical and functionally equivalent parts are provided with the same reference signs.

In FIG. 5, the supporting device 34 is shown in the assembly position. The supporting device 34 of the second embodiment differs from the supporting device 34 of the first embodiment in that the supporting device 34 is provided for multiple nozzle boxes 18 simultaneously and accordingly comprises multiple rails 50.

As many rails 50 are provided as the supporting device 34 intends to receive nozzle boxes 18; in the shown embodiment, four rails 50 and four nozzle boxes 18 are provided.

The supporting device 34 of the second embodiment comprises two first supports 52 that are connected to each other via a first longitudinal brace 72.

The first sides of the rails 50 are attached to the first longitudinal brace 72. In particular, the rails 50 rest with their first ends on the first longitudinal brace 72. Moreover, the supporting device 34 has two second supports 54 and can have a second longitudinal brace 74 that connects the two second supports 54 to each other.

For example, the second ends of the rails 50 are attached pivotably to the second longitudinal brace 74.

The first longitudinal brace 72 and the second longitudinal brace 74 extend in the drawing direction R and the rails 50 run transversely to the longitudinal braces 72, 74.

It is conceivable that in addition at least one, for example two cross braces are provided (indicated by dashed lines in FIG. 5), which connect the longitudinal braces 72, 74. The supporting device 34 can then have a frame that comprises the longitudinal braces 72, 74 and said at least one cross brace.

The spindle nut 66 of the actuation device 56 is provided on the first longitudinal brace 72, in particular in the centre of the first longitudinal brace 72 in relation to the drawing direction R.

It is also conceivable in this embodiment that the actuation device 56 is not permanent, i.e. is attached detachably to the remaining supporting device 34.

By means of the actuation device 56, the first longitudinal brace 72 and thus the first ends of all rails 50 can be moved upwards or downwards simultaneously.

The second longitudinal brace 74 has joints, whose pivot axes extend in the drawing direction R and by means of which the second ends of the rails 50 are attached pivotably on the second supports 54.

Transitioning the supporting device 34 of the second embodiment from the operating position into the assembly position and vice versa corresponds to the transitioning described for the first embodiment.

By means of the supporting device 34 of the second embodiment, multiple nozzle boxes can be brought into the assembly position simultaneously, thereby accelerating the replacement process further.

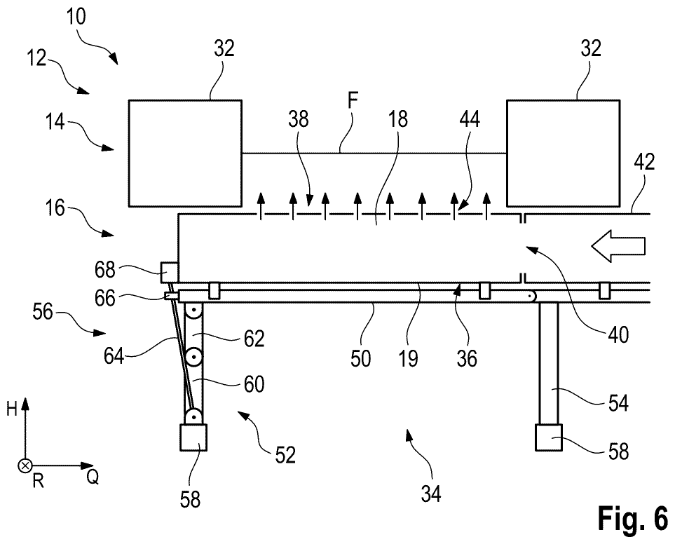

In FIG. 6, a further embodiment of the disclosure is shown that largely corresponds to the first embodiment so that that only the differences are discussed hereinafter.

Identical and functionally equivalent parts are provided with the same reference signs.

In the embodiment according to FIG. 6, the nozzle box 18 is designed differently from the first embodiment.

The nozzle box 18 does not comprise an attachment, but only a base body 19. The outflow openings 44 are arranged on the upper side or outlet side 38 of the base body.

The nozzle box 18 of this third embodiment can correspond to the base body 19 of the nozzle box 18 of the first embodiment, on which the outflow openings 44 are provided.

As can be seen in FIG. 6, the nozzle box 18 of this embodiment does not project into the spacing between both transport rails 32, but rather is situated below the transport rails 32.

Wings 46 can also be provided on the nozzle box 18 in this embodiment as previously described.

1. A nozzle box device for an oven of a stretching unit, comprising:
a nozzle box and a supporting device for the nozzle box,
wherein the supporting device comprises a first support and a second support,
wherein the nozzle box is connected to the first support and to the second support,
wherein the first support is designed to be height adjustable in such a way, that the nozzle box is adjustable between an operating position and an assembly position, and
wherein a first end of the nozzle box is situated lower in the assembly position than in the operating position.

2. The nozzle box device according to claim 1, wherein the supporting device comprises a rail, on which the nozzle box is mounted, wherein the rail is connected on one first side to the first support and on one second side to the second support, wherein a first end of the rail is situated lower in the assembly position than in the operating position.

3. The nozzle box device according to claim 1, wherein at least one of the rail or the nozzle box are at least one of arranged horizontally in the operating position, or tilted in relation to a horizontal plane when being adjusted from the operating position into to the assembly position.

4. The nozzle box device according to claim 1, wherein the first support comprises two members which are attached pivotably to each other and at least one of the members is pivotable in relation to at least one of the rail or the nozzle box.

5. The nozzle box device according claim 1, wherein the second support is at least one of a static support, or having attached pivotably at least one of the rail or the nozzle box.

6. The nozzle box device according to claim 1, wherein the nozzle box is at least one of arranged to be slidable on the rail, or removable from the supporting device via the first end of the rail.

7. The nozzle box device according to claim 1, wherein the supporting device comprises two first supports and a first longitudinal brace, wherein the first longitudinal brace connects the two first supports to each other.

8. The nozzle box device according to claim 1, wherein the supporting device comprises two second supports and a second longitudinal brace, wherein the second longitudinal brace connects the two second supports to each other.

9. The nozzle box device according to claim 7, wherein at least one of the rail or the nozzle box extend transversely to at least one of the first or second longitudinal braces and/or are attached to at least one of the first or second longitudinal braces.

10. The nozzle box device according to claim 9, wherein the supporting device comprises at least one of multiple rails or multiple nozzle boxes which are aligned parallel to each other and which attach next to each other on at least one of the first or second longitudinal braces.

11. The nozzle box device according to claim 1, wherein the supporting device comprises an actuation device, wherein the actuation device is configured to adjust the height of the first support.

12. The nozzle box device according to claim 11, wherein the actuation device is a screw jack comprising a threaded spindle and a spindle nut.

13. The nozzle box device according to claim 1, wherein the nozzle box device comprises multiple nozzle boxes.

14. The nozzle box device according to claim 13, wherein the nozzle boxes are at least one of aligned parallel to each other, arranged adjacent to each other in the drawing direction, or arranged transversely to the drawing direction.

15. The nozzle box device according to claim 13, wherein a cover separate from the nozzle boxes is arranged between two adjacent nozzle boxes; and/or wherein a perforated wing protrudes on the outlet side of the nozzle box in the drawing direction towards an adjacent nozzle box.

16. The nozzle box device according to claim 1, wherein the nozzle box comprises a plurality of outflow openings which are provided on the outlet side of the nozzle box and/or that the nozzle box has an inlet side comprising an air inlet opening, wherein the inlet side is located on the second side of the nozzle box.

17. The nozzle box device according to claim 1, wherein the nozzle box comprises a base body and an attachment which is attached to the base body, wherein the attachment comprises the outflow openings.

18. A stretching unit comprising a film transport system and an oven comprising a nozzle box device, the nozzle box device comprising a nozzle box and a supporting device for the nozzle box,
wherein the supporting device comprises a first support and a second support,
wherein the nozzle box is connected to the first support and to the second support,
wherein the first support is designed to be height adjustable in such a way, that the nozzle box is adjustable between an operating position and an assembly position, wherein a first end of the nozzle box is situated lower in the assembly position than in the operating position.

19. The stretching unit according to claim 18, wherein the film transport system comprises two transport rails which are arranged in the transverse direction at a spacing from each other, wherein at least one of:
the nozzle box is removable from the oven in the assembly position of the supporting device via a removal path below one of the transport rails, or
the nozzle box is arranged in the operating position of the supporting device at least in part within the spacing.

20. The stretching unit according to claim 18, wherein the stretching unit comprises an air supply, wherein the inlet side of the nozzle box connects to the air supply in the operating position of the supporting device.
